(19) United States
(12) Patent Application Publication
(10) Pub. No.: US 2019/0001721 A1
(43) Pub. Date: Jan. 3, 2019

(54) POINT GIVING SYSTEM, MANAGEMENT SERVER APPARATUS, AND POINT GIVING METHOD

(71) Applicant: CANON KABUSHIKI KAISHA, Tokyo (JP)

(72) Inventor: Hiroki Anai, Tokyo (JP)

(21) Appl. No.: 16/014,858

(22) Filed: Jun. 21, 2018

(30) Foreign Application Priority Data
Jun. 30, 2017 (JP) 2017-129175

(51) Int. Cl. B41J 29/393; B41J 2/175; G06Q 30/02

(52) U.S. Cl. CPC B41J 29/393; G06Q 30/0236; G06Q 30/0212; B41J 2/17546

(57) ABSTRACT

The present invention is a point giving system including an image forming apparatus and a management server apparatus connected to each other via a network, and the image forming apparatus includes: a generation unit configured to generate job log information including printing information or ink tank information on the image forming apparatus in accordance with execution of a job; and a transmission unit configured to transmit job log information generated by the generation unit and an identifier identifying the image forming apparatus to the management server apparatus, and the management server apparatus includes: a registration unit configured to register an identifier of the image forming apparatus and user information in association with each other; a reception unit configured to receive an identifier and job log information transmitted by the transmission unit; and a point giving unit configured to give a point to a user of user information registered by the registration unit in association with an identifier received by the reception unit in accordance with job log information received by the reception unit.

### BACKGROUND OF THE INVENTION

### Field of the Invention

The present invention relates to a point giving system for giving a point to a user in accordance with a job history of an image forming apparatus, a management server apparatus, and a point giving method.

### Description of the Related Art

Conventionally, a system to give a special favor to a user in accordance with a use amount of an ink cartridge in a printer apparatus, and the like is known. Japanese Patent Laid-Open No. 2006-344225 has disclosed a method of giving a special favor in accordance with an accumulated use amount by reading an accumulated use amount of ink from a recovered ink cartridge after use.

However, with the method disclosed in Japanese Patent Laid-Open No. 2006-344225, a special favor is given to a user based on the accumulated use amount stored in the ink tank itself after the ink tank is recovered, and therefore, it is not possible to give a point to a user real time.

Consequently, an object of the present invention is to give a point real time for a job performed in a printer apparatus.

### SUMMARY OF THE INVENTION

In order to achieve the above-described object, the present invention is a point giving system including an image forming apparatus and a management server apparatus connected to each other via a network, and the image forming apparatus includes: a generation unit configured to generate job log information including printing information or ink tank information on the image forming apparatus in accordance with execution of a job; and a transmission unit configured to transmit job log information generated by the generation unit and an identifier identifying the image forming apparatus to the management server apparatus, and the management server apparatus includes: a registration unit configured to register an identifier of the image forming apparatus and user information in association with each other; a reception unit configured to receive an identifier and job log information transmitted by the transmission unit; and a point giving unit configured to give a point to a user of user information registered by the registration unit in association with an identifier received by the reception unit in accordance with job log information received by the reception unit.

Further features of the present invention will become apparent from the following description of exemplary embodiments with reference to the attached drawings.

### BRIEF DESCRIPTION OF THE DRAWINGS

FIG. 1 is a block diagram showing a configuration of a point giving system according to a first embodiment;

FIG. 2 is a block diagram showing a configuration of a management server apparatus according to the first embodiment;

FIG. 3 is a block diagram showing a configuration of a printer apparatus according to the first embodiment;

FIG. 4 is a flowchart showing a procedure of processing of the printer apparatus according to the first embodiment;

FIG. 5A is a table showing information (common information) common to printing or ink tank exchange;

FIG. 5B is a table showing printing information;

FIG. 5C is a table showing tank information;

FIG. 6 is a flowchart showing a procedure of processing of the management server apparatus according to the first embodiment;

FIG. 7 is a flowchart showing a procedure for giving a point in the management server apparatus according to the first embodiment;

FIG. 8 is a flowchart showing a procedure for giving a bonus point in a management server apparatus according to a second embodiment;

FIG. 9 is a flowchart showing a procedure for giving a bonus point in a management server apparatus according to a third embodiment; and

FIG. 10 is a flowchart showing a procedure for giving a bonus point in a management server apparatus according to a fourth embodiment.

### DESCRIPTION OF THE EMBODIMENTS

In the following, preferred embodiments of the present invention are explained in detail with reference to the attached drawings. The following embodiments are not intended to limit the present invention and all combinations of features explained in the present embodiments are not necessarily indispensable to the solution of the present invention.

### First Embodiment

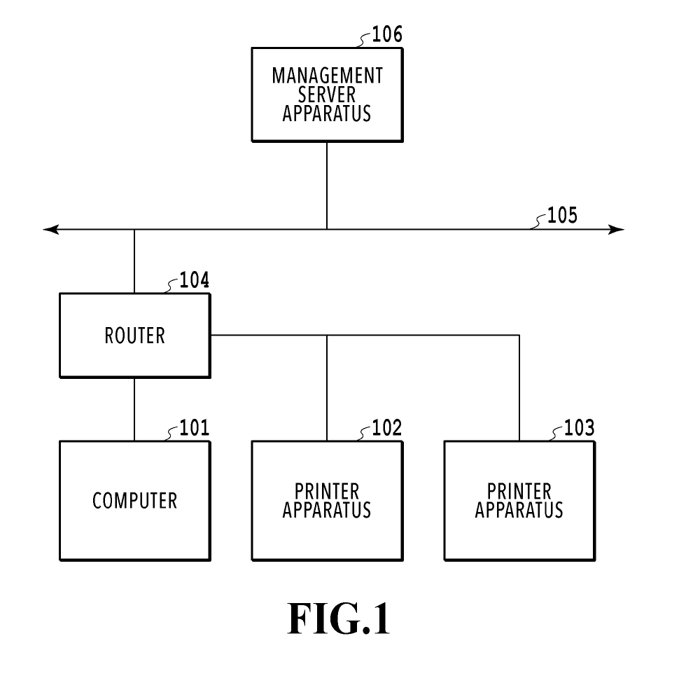

A system configuration of the present embodiment is explained with reference to FIG. 1. FIG. 1 is a block diagram showing a configuration of a point giving system according to the first embodiment. The point giving system includes a computer 101 and printer apparatuses 102 and 103 connected via a router 104, and a management server apparatus 106 connected via a predetermined communication line, such as Internet 105.

The computer 101 and the printer apparatuses 102 and 103 are each capable of communicating with one another via the router 104. Further, it is possible for each of the computer 101 and the printer apparatuses 102 and 103 and the management server apparatus 106 to communicate with one another via the Internet 105 and the management server apparatus 106 manages information transmitted from the printer apparatuses 102 and 103.

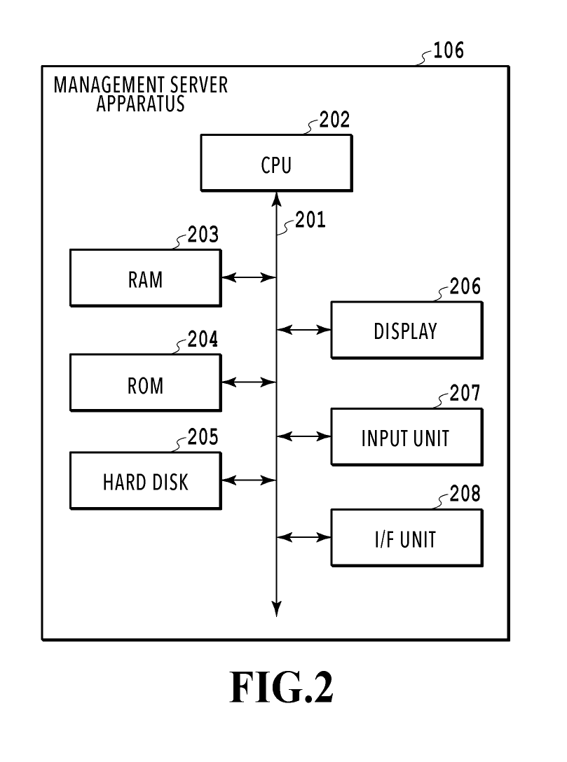

Next, a configuration of the management server apparatus 106 according to the present embodiment is explained with reference to FIG. 2. A CPU (Central Processing Unit) 202 performs operations, determination, and control of data and commands in accordance with software stored in a RAM 203, a ROM 204, or a hard disk 205. Specifically, the CPU 202 functions as a job log information extraction unit configured to extract job log information necessary for giving a point from job log information stored in, for example, the hard disk 205, a point giving unit configured to give a point, and so on.

The RAM (Random Access Memory) 203 is used as a temporary storage area at the time of the CPU 202 performing various kinds of processing. The ROM (Read Only Memory) 204 stores various programs and the like executed by the CPU 202. Further, the hard disk 205 stores, for example, an operating system, job log information transmitted from the printer apparatus 102 (103), and so on. That is, the hard disk 205 is shown as an example of a job log information storage unit.

A display 206 is a display device (for example, a liquid crystal display and the like) and also capable of displaying a GUI (Graphical User Interface) for operating the management server apparatus 106. An input unit 207 is an input device for a user to give various instructions to the management server apparatus 106 and for example, a mouse, a touch sensor, and so on.

An I/F unit 208 is an interface for performing transmission and reception of data with equipment connected by a wired or wireless LAN (Local Area Network) or a network (for example, Internet and the like) based on a protocol, such as TCP/IP. Specifically, for example, the I/F unit 208 functions as a job log information reception unit configured to receive job log information generated by the printer apparatus 102, and the like.

To the system bus 201, each of the CPU 202, the RAM 203, the ROM 204, the hard disk 205, and so on is connected so as to be capable of transmission and reception of data. Further, in FIG. 2, the configuration is shown in which each unit, such as the display 206 and the input unit 207, is integrated with the management server apparatus 106, but the configuration of the management server apparatus 106 is not necessarily limited to this. Consequently, it is also possible to make a virtual configuration of the management server apparatus 106 so that processing performed by the management server apparatus 106 can be operated (input) via the Internet.

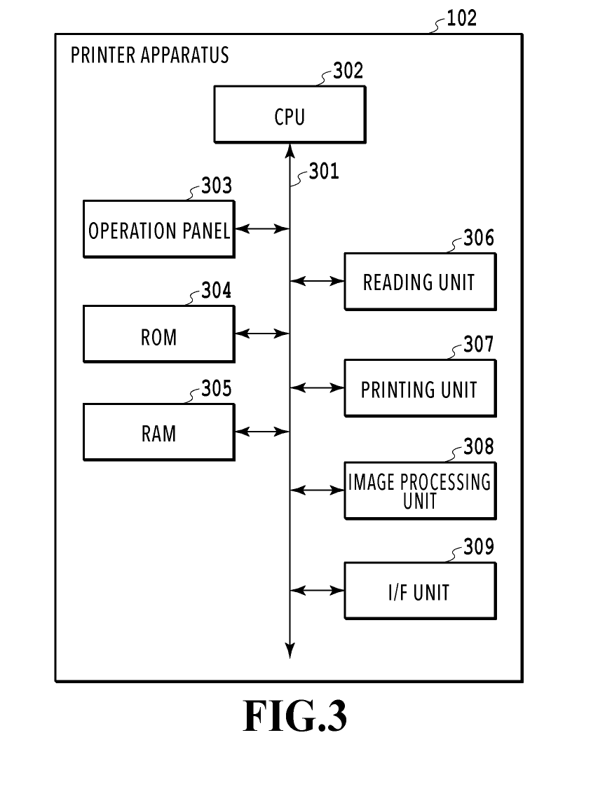

Next, the configuration of the printer apparatus 102 (103) according to the present embodiment is explained with reference to FIG. 3. The printer apparatus 102 is an image forming apparatus and includes a system bus 301, a CPU 302, an operation panel 303, a ROM 304, a RAM 305, a reading unit 306, a printing unit 307, an image processing unit 308, and an I/F unit 309.

The CPU 302 controls the printer apparatus 102 by executing programs stored in the ROM 304 on the RAM 305 in accordance with an operation of a user at the operation panel 303. Specifically, the CPU 302 functions as a job log information generation unit configured to generate log information on the job performed in the printer apparatus 102. The operation panel 303 includes keys and a touch pad for a user to perform an operation and a display that displays a screen for presenting images and various kinds of information to a user.

The ROM 304 stores control command programs and the like of the printer apparatus 102. The RAM 305 operates as a working memory of the CPU 302 and is further used as a storage area of a spooler of a print job.

The RAM 305 is mounted as a nonvolatile memory in the present embodiment and stores information possessed by the printer apparatus 102. Because of this, even in the case where the power source of the printer apparatus 102 is shut off, it is possible to store information possessed by the printer apparatus 102. Further, here, as information possessed by the printer apparatus 102, there is job log information, such as the sheet type and size used in a print job.

The reading unit 306 includes an optical sensor for reading a document and generates an image read by the optical sensor on the RAM 305. The printing unit 307 includes an ink tank storing ink, a print head for ejecting ink, a conveyance unit configured to convey a printing sheet, and so on and prints an image on a printing medium by an ink jet method. The printing method in the printing unit 307 is not necessarily limited to the ink jet method and for example, it is also possible to print an image by an electrophotographic method.

The image processing unit 308 performs image processing so that an image (for example, a document and the like) read by the reading unit 306 can be printed in the printing unit 307. Further, due to this, a copy function is implemented. The I/F unit 309 is an interface for performing transmission and reception of data with equipment connected by a wired or wireless LAN or a network (for example, the Internet and the like) based on a protocol, such as TCP/IP. The job log information stored in the RAM 305 is transmitted to the management server apparatus 106 via the I/F unit 309. That is, the I/F unit 309 is shown as an example of a job log information transmission unit configured to transmit generated job log information to the management server apparatus 106.

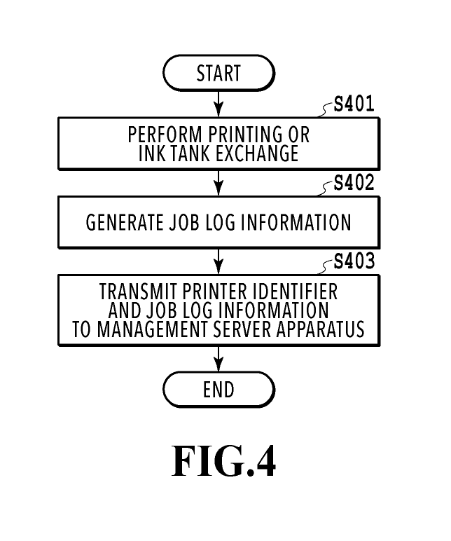

Next, the procedure of processing of the printer apparatus 102 (103) according to the present embodiment is explained by using a flowchart shown in FIG. 4. The printer apparatus 102 generates job log information each time printing or ink tank exchange is performed (S401) in the printer apparatus 102 (S402). Although details of job log information will be described later, in the present embodiment, job log information is not generated by accumulating a job log for each item making up the job log information, but is generated for each job unit at the time of execution of a job.

Lastly, the printer apparatus 102 transmits a printer identifier uniquely identifying the printer apparatus 102, which is allocated in advance by the management server apparatus 106, and generated job log information to the management server apparatus 106 (S403).

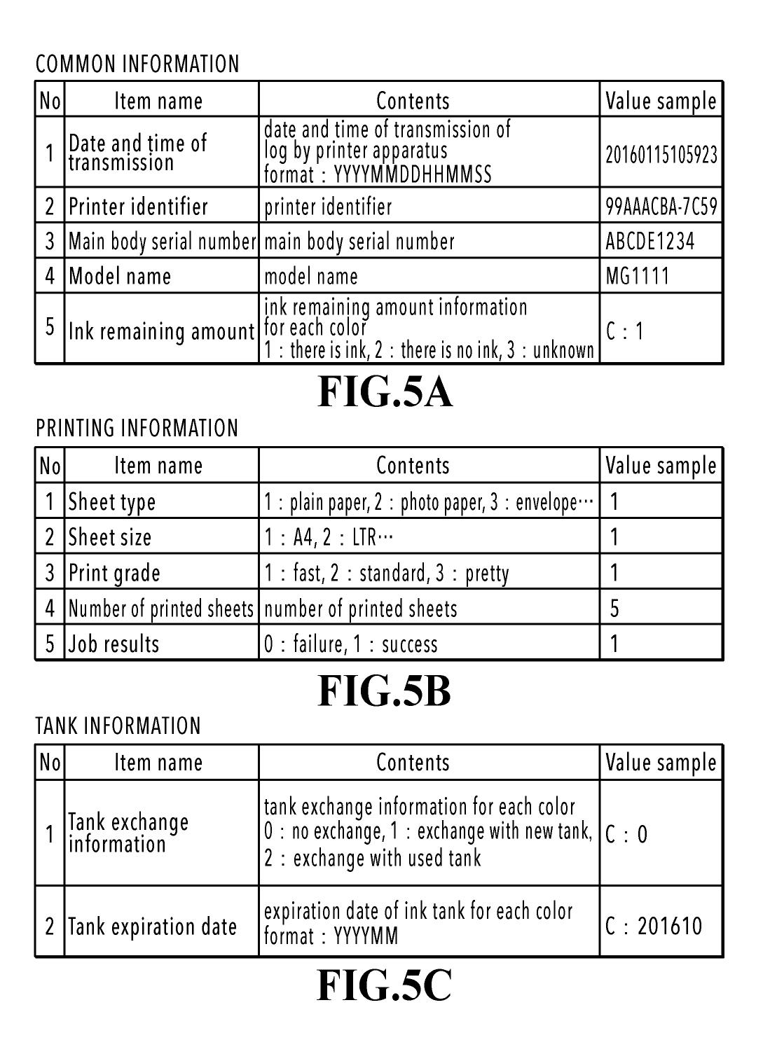

FIG. 5A to FIG. 5C are tables showing details of job log information. The job log information includes common information (FIG. 5A) common to printing or ink tank exchange, setting information (printing information (FIG. 5B)), and tank information (FIG. 5C). Here, in the case where printing is performed, job log information including common information and printing information is generated and in the case where ink tank exchange is performed, job log information including common information and tank information (to be more exact, ink tank information) is generated.

First, each item of common information is explained with reference to FIG. 5A. “Date and time of transmission” is the date and time of transmission of job log information by the printer apparatus 102 and “Printer identifier” is the identifier uniquely identifying the printer apparatus 102, and is the identifier allocated in advance to the printer apparatus 102 by the management server apparatus 106. “Printer identifier” is received from the management server apparatus 106 at the time of registering the printer apparatus 102 to the management server apparatus 106 and stored in the printer apparatus 102.

As the method of registration described above, it is possible to apply various methods. For example, identification information identifying a printer, such as “Main body serial number” and “MAC address”, to be described later, is transmitted from the printer apparatus 102 to the management server apparatus 106 at the time of registration and the management server apparatus 106 issues ID corresponding to the identification information to the printer apparatus 102. Then, a user inputs ID displayed or printed by the printer apparatus 102 and user information for making use of the point giving service by the management server apparatus 106 to the management server apparatus 106 by a Web browser of the printer apparatus 102 or another apparatus. Then, the management server apparatus 106 issues “Printer identifier” of the printer apparatus 102 and registers “Printer identifier” in association with the above-described user information and transmits “Printer identifier” to the printer apparatus 102. Due to this, it is possible for the management server apparatus 106 to give a point to a user of the user information registered in association with “Printer identifier” in question based on the job log information received along with “Printer identifier”.

Further, the above-described “Printer identifier” is not limited to one that uniquely identifies the printer apparatus 102 and may be one for identifying a plurality of printers. For example, for a plurality of printers purchased by an office and the like, a common printer identifier may be allocated. For example, in the case where the registration method of a printer is that described above, it is assumed that common user information (for example, user information on the manager of a printer) is input to the management server apparatus 106 at the time of each of a plurality of printers being registered. In this case, it may also be possible for the management server apparatus 106 to issue identical “Printer identifier” for the same user information. Due to this, “Printer identifier” identifying a plurality of printers is stored in each of the plurality of printers.

Further, “Main body serial number” is an identifier allocated in advance at the time of manufacturing of a printer and “Model name” is a character string indicating the name of the model of the printer apparatus 102. Information on “Ink remaining amount” is stored for each color and “Ink remaining amount” includes a combination of a character string indicating a color and a numerical value indicating an ink remaining amount value. As a supplement, the remaining amount value is set to three values in accordance with the ink remaining amount, that is, “1” in the “there is ink” state, “2” in the “there is no ink” state indicating that there is no ink, and “3” in the unknown state. Further, in FIG. 5A, the value sample “C: 1” shown in the box to the right indicates that “cyan” indicated by “C” is in the “there is ink” state.

Next, each item of printing information is explained with reference to FIG. 5B. The printing information indicates various settings used at the time of the printer apparatus 102 performing a print job and includes “Sheet type”, “Sheet size”, “Print grade”, “Number of printed sheets”, and “Job results” as shown in FIG. 5B.

Each item of the printing information is indicated by a numerical value and in the case of “plain sheet”, “Sheet type” is indicated by “1”, in the case of “photo sheet”, by “2”, and in the case of “envelope”, by “3”. Similarly, in the case of “A4”, “Sheet size” is indicated by “1”, in the case of “LTR”, by “2”, and so on.

Further, in the case of “fast”, “Print grade” is indicated by “1”, in the case of “standard”, by “2”, and in the case of “pretty”, by 3″. “Number of printed sheets” is information indicating the number of printed sheets (that is, printed sheet number information) and for example, in the case where a five-page document is printed, “Number of printed sheets” is set to “5”. To be more exact, “Number of printed sheets” is indicated by the number of printed sides and in the case of blank sheet printing, this is not counted. Further, in the case of division printing, such as 2-in-1 printing, “1” is counted for one printed side and in the case of both-side printing, “2” is counted for two printed sides, that is, the surface and the backside.

“Job results” indicates the results of a print job and in the case where printing fails for some error, “Job results” is indicated as “0” and in the case where printing is completed successfully to the last, “Job results” is indicated as “1”. A point is given for a print job only in the case where the job is completed normally. Consequently, in the case where “Job results” is “0: failure”, no point is given and only in the case of “1; success”, a point is given. Further, the number of points to be given is determined based on the “Number of printed sheets” in principle and for example, in the case of printing of one sheet, one point is given and in the case of printing of five sheets, five points are given.

Lastly, each item of the tank information is explained with reference to FIG. 5C. “Tank exchange information” is information indicating which kind of ink tank the ink tank is exchanged with in the printer apparatus 102 and in the case of “no exchange”, “Tank exchange information” is set to “0”, in the case of “exchange with new tank”, to “1”, and in the case of “exchange with used tank”, to “2”.

“Tank expiration date” indicates the date until which the ink tank mounted on the printer apparatus 102 can be used. Information on “Tank exchange information” and “Tank expiration date” is stored for each color as in the case of “Ink remaining amount” of the common information (FIG. 5A). Further, the job log information printed in the printer apparatus 102 is not necessarily limited to the items shown in FIG. 5A to FIG. 5C. Consequently, items other than the items shown in FIG. 5A to FIG. 5C, for example, such as the color/monochrome setting and the day on which the use of an ink tank is started, may be included.

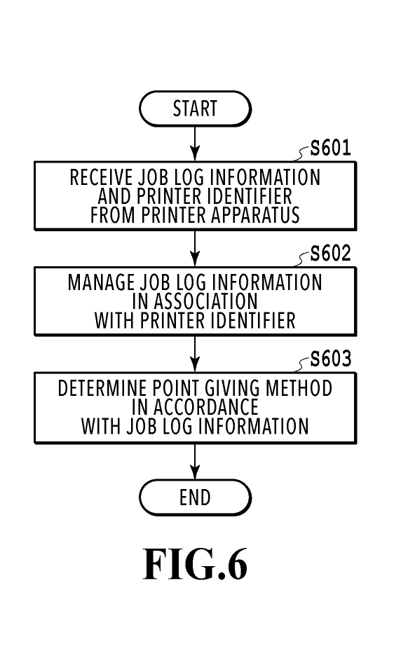

Next by using a flowchart in FIG. 6, the procedure of processing of the management server apparatus 106 according to the present embodiment is explained. The management server apparatus 106 receives the job log information and the printer identifier transmitted from the printer apparatus 102 (S601) and manages (stores) the job log information in association with the printer identifier (S602). Then, the management server apparatus 106 determines a point giving method in accordance with the contents of the received job log information (S603).

By managing the job log information in association with the printer identifier as described above, it is made possible to verify the job log information for each printer apparatus 102. It is possible to implement giving a point to a user by associating information on a user, who is the owner of the printer apparatus 102, and “Printer identifier” with each other in the management server apparatus 106.

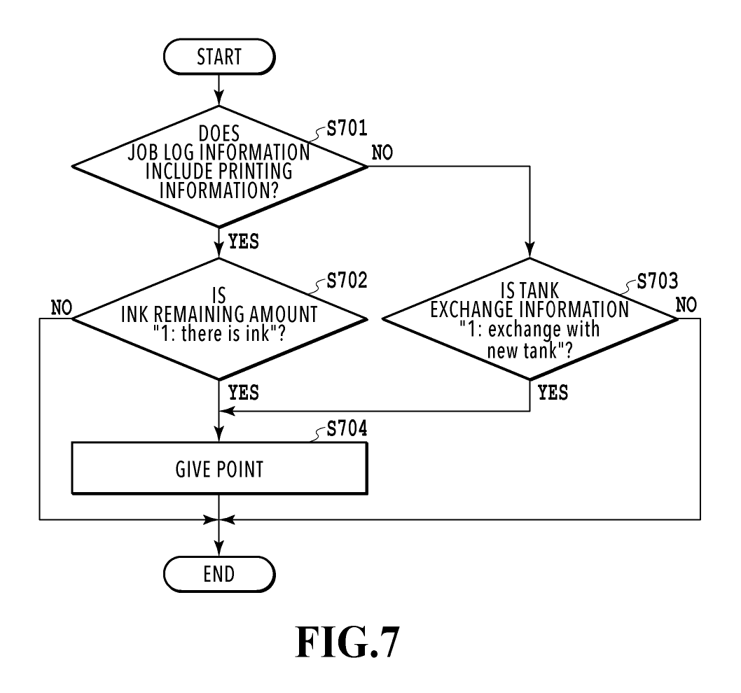

FIG. 7 is a flowchart showing a procedure for giving a point in the management server apparatus 106. The management server apparatus 106 determines whether or not the received job log information is job log information including printing information (S701) and in the case of the job log information including printing information (S701 Yes), advances the processing to step S702.

The management server apparatus 106 determines whether or not “Ink remaining amount” is “1: there is ink” by referring to “Ink remaining amount” of the job log information (common information) (S702) and in the case of “1: there is ink”, advances the processing to step S704. After advancing the processing to step S704, the management server apparatus 106 gives a point (S704).

In the case where “Ink remaining amount” is not “1: there is ink” (that is, in the case where “Ink remaining amount” is “2: there is no ink” or “3: unknown”) (S702 No) at step S702, the management server apparatus 106 does not give a point.

Further, in the case where the received job log information is not job log information including printing information (that is, in the case of the job log information including tank information) (S701 No) at step S701, the management server apparatus 106 advances the processing to step S703. Then, the management server apparatus 106 refers to “Tank exchange information” and determines whether or not the value thereof is “1: exchange with new tank” (S703). Then, in the case where “Tank exchange information” is “1: exchange with new tank” (S703 Yes), the management server apparatus 106 gives a point (S704). In the case where “Tank exchange information” is “0: no exchange” or “2: exchange with used tank” (S703 No), the management server apparatus 106 does not give a point.

As explained above, the printer apparatus 102 generates job log information in units of jobs and transmits the generated job log information. Upon receipt of the job log information, it is possible for the management server apparatus 106 to give a point real time in units of jobs in accordance with the condition to give a point (that is, the state information (for example, ink remaining amount and the like) of the printer apparatus 102). Due to this, it is possible to reduce the possibility that the job log (point) is lost even in the case where failure, exchange, or the like of the printer apparatus 102 occurs.

Further, the management server apparatus 106 manages the point that is given in association with the printer identifier, and therefore, for example, even in the case where the printer apparatus 102 or a user is changed, it is possible to easily move the point. Furthermore, as described above, point is given so as to prompt a user to exchange the ink tank. Due to this, it is possible to avoid in advance the possibility that printing undesirable for a user is performed by printing processing being performed in the state where there is no ink and the possibility that the printer apparatus 102 (103) fails.

### Second Embodiment

Next, a second embodiment is explained. In the following explanation, the drawings in common to those of the first embodiment and explanation thereof are omitted and only different points are explained.

In the first embodiment described above, the determination relating to giving a point is performed by using “Ink remaining amount” and “Tank exchange information”. Consequently, in the second embodiment, determination relating to giving a bonus point is performed by using “Date and time of transmission”. What is different from the first embodiment is the giving method of a point shown at step S603 in FIG. 6 and the processing of the printer apparatus 102 (103) and the management server apparatus 106 is the same as that in the first embodiment.

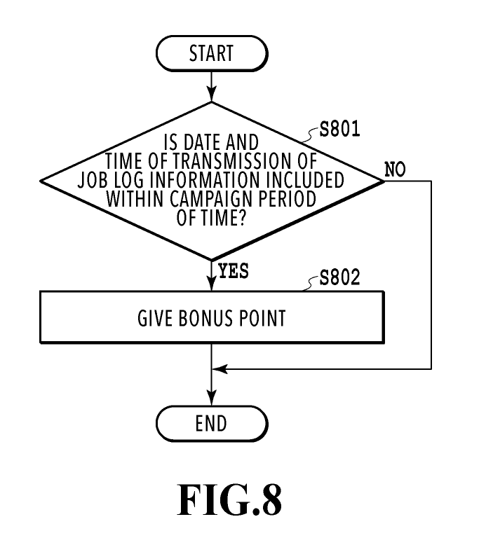

FIG. 8 is a flowchart showing a procedure for giving a bonus point in the management server apparatus 106. The management server apparatus 106 refers to “Date and time of transmission” of the job log information (common information) and determines whether or not the date and time of transmission of the job log information is included within a campaign period of time set in advance (S801). In the case where the date and time of transmission of the job log information is included within the campaign period of time set in advance (S801 Yes), a bonus point is given, in addition to the normal point shown in FIG. 7 (S802).

According to the present embodiment, it is possible for the management server apparatus 106 to give a bonus point in addition to the normal point by taking only the job log information transmitted during a predetermined period of time as a target.

### Third Embodiment

Next, a third embodiment is explained. In the following explanation, the diagrams in common to those of the first embodiment and explanation thereof are omitted and only different points are explained.

In the third embodiment, determination relating to giving a bonus point is performed by using “Sheet type”, “Sheet size”, and “Print grade”. As in the second embodiment, what is different from the first embodiment is the giving method of a point shown at step S603 in FIG. 6 and the processing of the printer apparatus 102 (103) and the management server apparatus 106 other than that is the same as in the first embodiment.

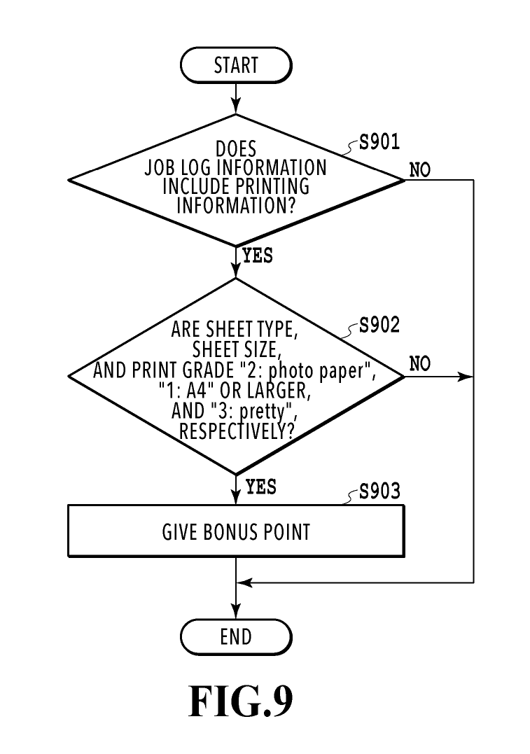

FIG. 9 is a flowchart showing a procedure for giving a bonus point in the management server apparatus 106. The management server apparatus 106 determines whether or not the received job log information is job log information including printing information (S901) and in the case of the job log information including printing information (S901 Yes), advances the processing to step S902.

The management server apparatus 106 determines whether or not “Sheet type” is “2: photo paper”, “Sheet size” is “1: A4” or larger, and “Print grade” is “3: pretty” of the job log information (printing information) (S902). Here, relating to the determination of whether or not the “Sheet size” is “1: A4” or larger, although not shown schematically in FIG. 5B, for example, “A3” is indicated by “3”, “A4” is indicated by “4”, and so on and whether or not the “Sheet size” is “A4” size or larger is determined from the value. Then, in the case where all the set conditions are satisfied at step S902 (S902 Yes), the management server apparatus 106 advances the processing to step S903 and gives a bonus point in addition to the normal point.

In the case where the received job log information is not job log information including printing information (that is, in the case of the job log information including tank information) at step S901, the processing shown in FIG. 9 is terminated without giving a bonus point. Further, in the case where all the conditions described above are not satisfied at step S902 (S902 No) also, the processing shown in FIG. 9 is terminated similarly without giving a bonus point.

According to the present embodiment, it is possible for the management server apparatus 106 to give a bonus point in addition to the normal point by taking a job that consumes more ink as a target (that is, in the case where the amount of ink to be consumed is larger than a predetermined amount). That is, it is made possible to give more points.

### Fourth Embodiment

Next, a fourth embodiment is explained. In the following explanation, the drawings in common to those of the first embodiment and explanation thereof are omitted and only different points are explained.

In the fourth embodiment, determination relating to giving a bonus point is performed by using “Tank expiration date (that is, expiration date of ink tank)”. As in the second and third embodiments, what is different from the first embodiment is the giving method of a point shown at step S603 in FIG. 6 and the processing of the printer apparatus 102 (103) and the management server apparatus 106 other than that is the same as that in the first embodiment.

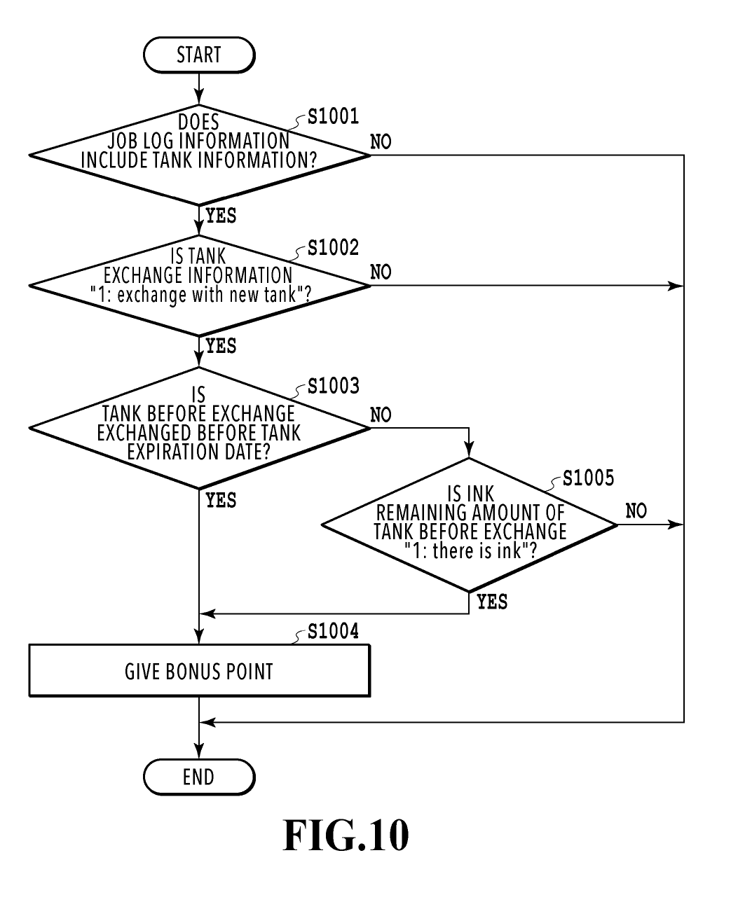

FIG. 10 is a flowchart showing a procedure for giving a bonus point in the management server apparatus 106. The management server apparatus 106 determines whether or not the received job log information is job log information including tank information (S1001) and in the case of the job log information including tank information (S1001 Yes), advances the processing to step S1002.

The management server apparatus 106 refers to “Tank exchange information” and determines whether or not “Tank exchange information” is “1: exchange with new tank” (S1002). Then, in the case where “Tank exchange information” is “1: exchange with new tank” (S1002 Yes), the management server apparatus 106 causes the processing to advance to S1003.

Then, at step S1003, the management server apparatus 106 searches the job log information (tank information) received hitherto and determines whether or not the ink tank already installed immediately before the exchange is exchanged before the ink tank expiration date from “Tank expiration date” (S1003). In more detail, the management server apparatus 106 determines whether or not the job log information (“Date and time of transmission”) after the exchange of the ink tank is before the date of “Tank expiration date” of the ink tank already installed immediately before the exchange. In the case where it is determined that the ink tank already installed immediately before the exchange is determined to be one exchanged before the ink tank expiration date at step S1003 (S1003 Yes), the management server apparatus 106 gives a bonus point in addition to the normal point.

Further, in the case where it is determined that the ink tank already installed immediately before the exchange is not exchanged before the ink tank expiration date at step S1003 (S1003 No), the management server apparatus 106 causes the processing to advance to step S1005. Then, at step S1005, the management server apparatus 106 determines whether or not “Ink remaining amount” of the ink tank already installed immediately before the exchange is “1: there is ink” from the job log information received hitherto. In the case where it is determined that “Ink remaining amount” of the ink tank already installed immediately before the exchange is “1: there is ink” at S1005 (S1005 Yes), the management server apparatus 106 gives a bonus point in addition to the normal point (S1004).

In the case where the job log information received at step S1001 is not job log information including tank information (that is, in the case of the job log information including printing information), the processing shown in FIG. 10 is terminated without giving a bonus point. Further, in the case where “Tank exchange information” is not “1: exchange with new tank” (S1002 No) also, the processing shown in FIG. 10 is terminated similarly without giving a bonus point. In addition, in the case where the ink tank already installed immediately before the exchange is not exchanged before the expiration date and where “Ink remaining amount” of the ink tank is not “1: there is ink” also, the processing shown in FIG. 10 is terminated similarly without giving a bonus point.

According to the present embodiment, it is possible for the management server apparatus 106 to suppress printing undesirable for a user from being performed by an ink tank whose expiration date has been reached being used.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, it is possible to give a point real time to a job that is performed in a printer apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-129175, filed Jun. 30, 2017, which is hereby incorporated by reference wherein in its entirety.

What is claimed is:

1. A point giving system comprising an image forming apparatus and a management server apparatus connected to each other via a network, wherein
the image forming apparatus comprises:
a generation unit configured to generate job log information including printing information or ink tank information on the image forming apparatus in accordance with execution of a job; and
a transmission unit configured to transmit job log information generated by the generation unit and an identifier identifying the image forming apparatus to the management server apparatus, and
the management server apparatus comprises:
a registration unit configured to register an identifier of the image forming apparatus and user information in association with each other;
a reception unit configured to receive an identifier and job log information transmitted by the transmission unit; and
a point giving unit configured to give a point to a user of user information registered by the registration unit in association with an identifier received by the reception unit in accordance with job log information received by the reception unit.

2. A management server apparatus connected with an image forming apparatus via a network, the management server apparatus comprising:
a registration unit configured to register an identifier of the image forming apparatus and user information in association with each other;
a job log information reception unit configured to receive job log information generated in accordance with a job performed in the image forming apparatus and an identifier identifying the image forming apparatus; and
a point giving unit configured to give a point to a user of user information registered by the registration unit in association with an identifier received by the reception unit in accordance with job log information received by the reception unit.

3. The management server apparatus according to claim 2, comprising:
a storage unit configured to store the job log information in association with the identifier; and
an extraction unit configured to extract job log information used for determination of point giving from job log information stored in the storage unit.

4. The management server apparatus according to claim 2, wherein
the job log information includes printing information or ink tank information on the image forming apparatus.

5. The management server apparatus according to claim 4, wherein
the point giving unit gives a point in a case where the printing information is included in the job log information and in a case where it is determined that there is an amount of remaining ink in an ink tank installed in the image forming apparatus by the printing information.

6. The management server apparatus according to claim 5, wherein
the point giving unit determines a number of points to be given to the user based on printed sheet number information indicating a number of printed sheets included in the printing information.

7. The management server apparatus according to claim 4, wherein
the point giving unit gives a point in a case where the ink tank information is included in the job log information and in a case where it is determined that an ink tank exchanged in the image forming apparatus is a new ink tank by the ink tank information.

8. The management server apparatus according to claim 4, wherein
the point giving unit gives a bonus in a case where it is determined that a date and time of transmission of the job log information in the image forming apparatus is included within a predetermined period of time by the job log information.

9. The management server apparatus according to claim 4, wherein
the point giving unit gives a bonus point in a case where the printing information is included in the job log information and in a case where it is determined that an amount of ink consumed in the job is larger than a predetermined amount by the printing information.

10. The management server apparatus according to claim 9, wherein
the point giving unit determines whether an amount of ink consumed in the job is larger than a predetermined amount by using information relating to a sheet type, a sheet size, and a print grade included in the printing information.

11. The management server apparatus according to claim 4, wherein
the point giving unit gives a bonus point in a case where the ink tank information is included in the job log information, and in a case where it is determined that an ink tank exchanged in the image forming apparatus is a new ink tank by the ink tank information, and in a case where an ink tank is exchanged for the new ink tank before an expiration date of the ink tank immediately before exchange.

12. The management server apparatus according to claim 4, wherein
the point giving unit gives a bonus point in a case where the ink tank information is included in the job log information, and in a case where it is determined that an ink tank exchanged in the image forming apparatus is a new ink tank by the ink tank information, and in a case where an ink tank is exchanged for the new ink tank after an expiration date of the ink tank immediately before exchange, and in a case where it is determined that there is an amount of remaining ink in the ink tank immediately before the exchange.

13. A point giving method in a point giving system comprising an image forming apparatus and a management server apparatus connected to each other via a network, the point giving method comprising:
a generation step of generating, by a generation unit of the image forming apparatus, job log information including printing information or ink tank information on the image forming apparatus in accordance with execution of a job;
a transmission step of transmitting, by a transmission unit of the image forming apparatus, job log information generated at the generation step and identifier identifying the image forming apparatus to the management server apparatus;
a registration step of registering, by a registration unit of the management server apparatus, identifier of the image forming apparatus and user information in association with each other;
a reception step of receiving, by a reception unit of the management server apparatus, an identifier and job log information transmitted by the transmission unit; and
a point giving step of giving, by a point giving unit of the management server apparatus, a point to a user of user information registered at the registration step in association with an identifier received at the reception step in accordance with job log information received at the reception step.

14. The point giving method according to claim 13, wherein
the management server apparatus comprises a storage unit configured to store the job log information in association with the identifier; and
the point giving method further includes an extraction step of extracting, by an extraction unit of the management server apparatus, job log information used for determination of point giving from job log information stored in the storage unit.

15. The point giving method according to claim 13, wherein
the job log information includes printing information or ink tank information on the image forming apparatus.

16. The point giving method according to claim 15, wherein
at the point giving step, a point is given in a case where the printing information is included in the job log information and in a case where it is determined that there is an amount of remaining ink in an ink tank installed in the image forming apparatus by the printing information.

17. The point giving method according to claim 16, wherein
at the point giving step, a number of points to be given to the user is determined based on printed sheet number information indicating a number of printed sheets included in the printing information.

18. The point giving method according to claim 15, wherein
at the point giving step, a point is given in a case where the ink tank information is included in the job log information and in a case where it is determined that an ink tank exchanged in the image forming apparatus is a new ink tank by the ink tank information.

19. The point giving method according to claim 15, wherein
at the point giving step, a bonus point is given in a case where it is determined that a date and time of transmission of the job log information in the image forming apparatus is included within a predetermined period of time by the job log information.

20. The point giving method according to claim 15, wherein
at the point giving step, a bonus point is given in a case where the printing information is included in the job log information and in a case where it is determined the an amount of ink consumed in the job is larger than a predetermined amount by the printing information.
